(19) United States
(12) Patent Application Publication
(10) Pub. No.: US 2016/0226890 A1
(43) Pub. Date: Aug. 4, 2016

(54) METHOD AND APPARATUS FOR PERFORMING INTRUSION DETECTION WITH REDUCED COMPUTING RESOURCES

(71) Applicant: ICF International, Baltimore, MD (US)

(72) Inventor: Richard HARANG, Alexandria, VA (US)

(73) Assignee: ICF International, Baltimore, MD (US)

(21) Appl. No.: 14/052,153

(22) Filed: Oct. 11, 2013

(51) Int. Cl. H04L 29/06; H04W 12/12

(52) U.S. Cl. CPC H04L 63/1408; H04W 12/12

(57) ABSTRACT

A method and apparatus can be configured to receive, by a first network intrusion detection system, packet data that is transmitted in network traffic. The method can also include processing the received packet data, using feature hashing, into a hashed representation. The hashed representation approximates the expressiveness of a high-dimensional representation of the received packet data. The hashed representation can be stored using less memory compared to the high-dimensional representation. The method can also include classifying the hashed representation as either corresponding to a threat signature or as not corresponding to a threat signature.

### GOVERNMENT LICENSE RIGHTS

This invention was made with government support under W911QX-12-F-0052 awarded by the U.S. Army Research Laboratory. The government has certain rights in the invention.

### BACKGROUND

1. Field

Embodiments of the invention relate to performing intrusion detection with reduced computing resources.

2. Description of the Related Art

Network security systems rely on the ability to screen and monitor network traffic in order to identify unauthorized or malicious activity that may be considered harmful. In particular, network security systems seek to identify unwanted network usage while the usage is occurring or is about to occur so that appropriate action may be taken in response to the usage. In addition to identifying unwanted network usage, network security systems may record information about the unwanted network usage, attempt to prevent/stop the unwanted network usage, and/or report the unwanted network usage to appropriate personnel.

### SUMMARY

According to a first embodiment, a method includes receiving, by a first network intrusion detection system, packet data that is transmitted in network traffic. The method can include processing the received packet data, using feature hashing, into a hashed representation. The hashed representation approximates the expressiveness of a high-dimensional representation of the received packet data, and the hashed representation can be stored using less memory compared to the high-dimensional representation. The method can also include classifying the hashed representation as either corresponding to a threat signature or as not corresponding to a threat signature.

In the method of the first embodiment, the received packet data is not transformed into the high-dimensional representation.

In the method of the first embodiment, the method can further include comparing the determined classification to another classification. The another classification can be determined by a second network intrusion detection system.

In the method of the first embodiment, the method can also include updating the first intrusion detection system based on the comparing. The first intrusion detection system can be updated so that the determined classifications more closely resemble the classifications determined by the second network intrusion detection system.

In the method of the first embodiment, the receiving the packet data comprises receiving packet data transmitted in an ad-hoc wireless network.

In the method of the first embodiment, the processing the received packet data comprises using signed-feature hashing.

In the method of the first embodiment, the comparing comprises comparing the determined classification to another classification determined by SNORT.

In the method of the first embodiment, the updating comprises updating weightings for online learning of the first intrusion detection system.

In the method of the first embodiment, the updating can be performed on a single device using representative data and the learned weights are then transmitted in compact form to clients for use in intrusion detection without need to reference a secondary classifier.

According to a second embodiment, an apparatus can include at least one processor. The apparatus can also include at least one memory including computer program code. The at least one memory and the computer program code can be configured, with the at least one processor, to cause the apparatus at least to receive packet data that is transmitted in network traffic. The apparatus can also process the received packet data, using feature hashing, into a hashed representation. The hashed representation approximates the expressiveness of a high-dimensional representation of the received packet data, and the hashed representation can be stored using less memory compared to the high-dimensional representation. The apparatus can also classify the hashed representation as either corresponding to a threat signature or as not corresponding to a threat signature.

In the apparatus of the second embodiment, the received packet data is not transformed into the high-dimensional representation.

In the apparatus of the second embodiment, the apparatus can be further caused to compare the determined classification to another classification. The another classification can be determined by a second network intrusion detection system.

In the apparatus of the second embodiment, the apparatus can be further caused to update the first intrusion detection system based on the comparing. The first intrusion detection system can be updated so that the determined classifications more closely resemble the classifications determined by the second network intrusion detection system.

In the apparatus of the second embodiment, the receiving the packet data comprises receiving packet data transmitted in an ad-hoc wireless network.

In the apparatus of the second embodiment, the processing the received packet data comprises using signed-feature hashing.

In the apparatus of the second embodiment, the comparing comprises comparing the determined classification to another classification determined by SNORT.

In the apparatus of the second embodiment, the updating comprises updating weightings for online learning of the apparatus.

In the apparatus of the second embodiment, the updating can be performed on a single device using representative data and the learned weights are then transmitted in compact form to clients for use in intrusion detection without need to reference a secondary classifier.

According to a third embodiment, a computer program product can be embodied on a non-transitory computer readable medium. The computer program product can be configured to control a processor to perform a process comprising receiving, by a first network intrusion detection system, packet data that is transmitted in network traffic. The process can also include processing the received packet data, using feature hashing, into a hashed representation. The hashed representation approximates the expressiveness of a high-dimensional representation of the received packet data. The hashed representation can be stored using less memory compared to the high-dimensional representation. The process can also include classifying the hashed representation as either corresponding to a threat signature or as not corresponding to a threat signature.

In the computer program product of the third embodiment, the received packet data is not transformed into the high-dimensional representation.

In the computer program product of the third embodiment, the process can also include comparing the determined classification to another classification. The another classification can be determined by a second network intrusion detection system.

In the computer program product of the third embodiment, the process can also include updating the first intrusion detection system based on the comparing. The first intrusion detection system can be updated so that the determined classifications more closely resemble the classifications determined by the second network intrusion detection system.

In the computer program product of the third embodiment, the receiving the packet data comprises receiving packet data transmitted in an ad-hoc wireless network.

In the computer program product of the third embodiment, the processing the received packet data comprises using signed-feature hashing.

In the computer program product of the third embodiment, the comparing can include comparing the determined classification to another classification determined by SNORT.

In the computer program product of the third embodiment, the updating can include updating weightings for online learning of the first intrusion detection system.

In the computer program product of the third embodiment, the updating can be performed on a single device using representative data and the learned weights are then transmitted in compact form to clients for use in intrusion detection without need to reference a secondary classifier.

### BRIEF DESCRIPTION OF THE DRAWINGS

For proper understanding of the invention, reference should be made to the accompanying drawings, wherein:

FIG. 1 illustrates a flowchart of a method in accordance with embodiments of the invention.

FIG. 2 illustrates an apparatus in accordance with embodiments of the invention.

FIG. 3 illustrates an apparatus in accordance with embodiments of the invention.

### DETAILED DESCRIPTION

Intrusion detection systems (IDS) are systems that monitor network traffic within a network to catch unwanted activity. Network traffic generally refers to the transmitting and receiving of data packets between computers within the network. One type of intrusion detection is deep-packet inspection. Deep packet inspection examines the data packets within network traffic in order to detect specific signatures within the data packets. Each of the specific signatures can correspond to a specific potential/known threat to the network. As such, an IDS can detect the presence of potential/known threats by detecting the signatures that correspond to these potential/known threats.

A signature can be, for example, a substring of characters that corresponds to malicious data. A signature can also include a class of substrings. As discussed above, by detecting the specific signatures that correspond to the potential/known threats, an IDS can determine whether or not certain data packets within the network contain malicious data.

One example of a signature-based network IDS is SNORT. SNORT can monitor each packet of network traffic. However, one of the difficulties in using SNORT to perform intrusion detection is that running SNORT can be extremely resource intensive. Because using SNORT to perform intrusion detection can be very resource intensive, using SNORT to perform intrusion detection on wireless-network traffic can be difficult, as described in more detail below. Because SNORT has high resource requirements, it is often standard practice to run SNORT on its own dedicated system, especially when SNORT is performing intrusion detection on a larger network. Although SNORT is specifically mentioned as a resource-intensive IDS, the problem of using large amounts of computing resources is a problem that is common to any signature-based intrusion detection system.

In a wireless network, especially mobile ad-hoc networks, the wireless network may have a topology that constantly changes as computers/devices join and leave the network at different times and at different locations. A mobile ad-hoc network is generally considered to be a wireless network that operates in a peer-to-peer mode, without requiring the computers/devices to connect to a centralized wireless router. Such mobile ad-hoc networks are common for vehicle-based networks, for example. Each computer/device within such mobile ad-hoc networks may be in charge of forwarding traffic to other computers/devices within the network.

Due to the peer-to-peer operation of the ad-hoc networks, within these ad-hoc networks, there may not exist any centralized router through which all of the network's traffic travels. Therefore, in the absence of any centralized router at which SNORT (or some other signature-based IDS) can analyze all of the network traffic, SNORT (or some other signature-based network IDS) typically must be implemented at each individual computer of the ad-hoc network. In other words, in order to use the previous approaches (such as SNORT) to perform intrusion detection on every packet of the ad-hoc network traffic, the previous approaches would necessarily need to have a separate computing device (dedicated to running SNORT) for each computer/device of the wireless network.

In view of the above, using the previous approaches to perform intrusion detection may be undesirable if the network is an ad-hoc wireless network. Further, if a user of a mobile device wants to ensure that intrusion detection is performed on all traffic that is transmitted to and from the mobile device, the user of the mobile device may not want to use the previous approaches. Specifically, using the previous approaches may be undesirable to the mobile-device user because the user would likely prefer to not have any bulky computing device (which is dedicated to running intrusion detection in accordance with the previous approaches) to accompany the portable mobile device.

In view of the shortcomings associated with the previous approaches, embodiments of the present invention can perform functionality similar to SNORT while being implemented on smaller devices, with reduced computing resources. Algorithms of embodiments of the present invention can operate very efficiently and can perform similar functionality as compared to SNORT. Examples of smaller devices can be a mobile phone, a smart phone, a tablet, a personal-digital assistant, a device used in a vehicle-based network, or any other portable electronic device.

In embodiments of the present invention, an IDS can be implemented using any combination of hardware and/or software. One embodiment of the present invention can be implemented as a non-transitory computer-readable medium that includes instructions stored thereon. The IDS of certain embodiments of the present invention can be implemented by a device that is less expensive/bulky than the devices needed by the IDS of the previous approaches. In other embodiments, an IDS can be directly implemented on the portable/mobile device of the end user. In other words, in these embodiments, the IDS need not be implemented on any separate device accompanying the portable/mobile device of the end user. Embodiments of the present invention can provide the above-described advantages because, in general, embodiments of the present invention use less computing resources as compared to the previous approaches for performing intrusion detection.

In order for embodiments of the present invention to perform online learning, data (such as data contained within the network packets) is inputted/loaded into the IDS to be classified as either corresponding to a threat or not corresponding to a threat. The data contained within the network packets can generally be referred to as records. Although each record itself is small (in terms of the amount of memory necessary to store the record), the classifying is not performed directly on the record as-is because such classifying would generally require complex and expensive pattern-matching operations. Instead, the classifying should be performed on a high-dimensional representation of each record such that classifying these high-dimensional representations can be performed using fast linear operations (operations which are not complex/expensive). Certain embodiments of the present invention achieve the results of classifying high-dimensional representations without transforming the records into high-dimensional representations, as discussed in more detail below.

One type of high-dimensional representation can comprise N-gram representations. N-gram representations are generally considered to be a method for retaining relevant sequential information about a data series in a sparse and computationally efficient manner. N-gram representations can be used in conjunction with feature hashing to reduce the amount of computing resources that are necessary for intrusion detection, as described in more detail below. Feature hashing is generally considered to be a method of transforming sparse high-dimensional data into an approximately equivalent lower-dimensional space that is more computationally tractable.

Because each high-dimensional representation may be large (in terms of the amount of memory necessary to store the high-dimensional representation), each high-dimensional representation may need to be inputted/loaded one-at-a-time. However, some high-dimensional representations of the data record may be too large to be loaded into the memory of the IDS even one-at-a-time. As such, high-dimensional representations can be hashed into hashed representations that are small enough to be tractable. Feature hashing can be used to generate these hashed representations. Each hashed representation is a reduced, approximately equivalent representation of the high-dimensional representation. Each hashed representation can then be loaded into memory one-at-a-time. Although feature hashing is specifically mentioned in this example, other types of hashing can be used to generate the hashed representations as well.

When using feature hashing to process these records (represented in high-dimensional space), the records can be processed such that they are accurately represented in a lower-dimensional space to some desired degree of approximation. As discussed above, certain embodiments of the present invention achieve the result of performing classifying on a high-dimensional representation of the records without actually transforming each record into any high-dimensional representation. Specifically, instead of transforming the received records into high-dimensional representations, embodiments of the present invention can process the received records, using feature hashing, directly into hashed representations (which are represented in the lower-dimensional space). The hashed representation can approximate the expressiveness of a corresponding high-dimensional representation. As such, embodiments of the present invention can process the records into the hashed representations without first transforming the received records into the corresponding high-dimensional representations.

According to the Johnson-Lindenstrauss lemma, data points (corresponding to the records) that are represented in a high-dimensional space can also be represented in a lower-dimensional space where the distances between the data points remain approximately preserved. In other words, by using feature hashing, embodiments of the present invention can transform records represented in a high-dimensional space to a representation in a low-dimensional space, as described in more detail below. As such, embodiments of the present invention can more efficiently process records, the desired representation of which are too large to be loaded into the system memory.

With certain embodiments of the present invention, the feature hashing can be implemented using a ring buffer. By using a ring buffer, as described in more detail below, embodiments of the present invention can avoid/bypass transforming the received records to high-dimensional representations. Specifically, by using a ring buffer, embodiments of the present invention can bypass the construction of any high-dimensional feature vector that is typically necessary for transforming the received records to high-dimensional representations. In certain embodiments, a first “N” number of bytes of a record (corresponding to the first “N-gram”) can be loaded into an N-byte ring buffer. Instead of indexing a high-dimensional feature vector with the N bytes (where such indexing would typically be used to determine a high-dimensional representation), embodiments of the present invention can hash the N bytes and index a smaller hash table using that hashed value. Embodiments of the present invention can then read another byte into the ring buffer (which replaces the last byte of the ring buffer with the next byte of data from the record and increments the ‘head’ pointer for the buffer modulo the length of the buffer such that the buffer still has N bytes, but now contains the second N-gram) and hash the new set of N bytes to index the smaller hash table again. This process can continue through the remaining bytes of the record. As the process is performed for the remaining bytes of the record, certain embodiments can use salts and signed hashing, as described in more detail below.

Therefore, by performing feature hashing with the ring buffer, the amount of memory required to implement the above-described processing for the records is substantially less than the amount of memory required to transform the records to high-dimensional representations. Specifically, by performing feature hashing with the ring buffer, the amount of required memory corresponds to N bytes of memory for the ring buffer, plus key space for the smaller hash table, plus value space for keys that get any nonzero values, and some working memory for the hash algorithm. In contrast, the amount of memory required to transform a single record to a high-dimensional representation (within a 2⁴⁰-dimensional space) can require a 2⁴⁰-dimensional feature vector, and such a feature vector can require a substantial amount of memory.

In view of the above, by using feature hashing in the analysis of network traffic, embodiments of the present invention enable low-powered computers (such as mobile phones or embedded microcomputers) to perform the analysis of network traffic. Specifically, embodiments of the present invention can reduce processing time by reducing the dimensionality of the processed records using feature hashing. One embodiment of the present invention can use signed-feature hashing, for example.

Each N-gram can be associated with a hash table. Specifically, each N-gram can be associated with a unique position in the hash table. The hash table can be considered as representing a multiple-dimensional space where each of the locations of the hash table corresponds to a dimension of the multi-dimensional space.

If a record is represented as positions in the hash table (if the record is represented in the multi-dimensional space), signed-feature hashing can be used to reduce the high-dimensionality of the record (that is represented in the hash table). Once the dimensionality of the record is reduced, embodiments of the present invention can apply machine learning on the reduced space, as described in more detail below. For example, the machine learning can include performing linear classification by using stochastic gradient descent, as described in more detail below.

An example process for performing the above-described feature hashing is described immediately below. Embodiments of the present invention can split a content string (corresponding to the above-described record) into smaller portions (portions of the above-described record). For example, a given content string can be separated into portions of 5 bytes (“a 5-gram”). Although the present example uses “5-grams,” in other examples, the given content string can also be separated into portions different than 5 bytes as well.

For example, if the record/content-string is “A105BD70-A105B-4D10-BC91-41C88321347C,” the corresponding 5-grams can be [A105B], [105BD], [05BD7] . . . [1347C]. Each value of the 5-gram (each portion of a record) can then be represented as a point in a high-dimensional space of 2⁴⁰ points (2⁸×2⁸×2⁸×2⁸×2⁸). In other words, each value (represented by a single 5-gram) corresponds to a location/position in a hash table of 2⁴⁰ locations/positions. For example, the American-Standard-Code-for-Information-Interchange (ASCII) values within the 5-gram [1347C], as seen above, can be expressed, in binary, as [00110001 00110011 00110100 00110111 01000011]. This N-gram value can correspond to a single dimension [0011000100110011001101000011011101000011], in the 2⁴⁰ dimensional space. Each combination of bits of the 2⁴⁰ combinations can correspond to a single dimension in the 2⁴⁰-dimensional space. As such, in one embodiment, a hyperplane may be determined in the high-dimensional space such that most of the packets that are determined to be “threatening” fall on one side of the hyperplane and that most of the non-threatening packets fall on the other side of the hyperplane. However, as described above, certain embodiments of the present invention can achieve the results of classifying high-dimensional representations without actually transforming the records into high-dimensional representations.

As each N-gram is mapped to a dimension of the 2⁴⁰-dimensional space, the number of instances along each dimension is recorded. For example, in the above example, the content string has two 5-grams corresponding to the value of [A105B]. As such, once these two values of [A105B] are expressed in the 2⁴⁰-dimensional space, the dimension corresponding to [A105B] will have two recorded instances along the dimension (the value for that dimension is “incremented” twice).

Next, embodiments of the present invention can use signed-feature hashing to reduce the dimensionality of the data represented within the 2⁴⁰ space. For example, the dimensionality can be reduced from the 2⁴⁰ space to a lower-dimension space (such as a space of 2¹² dimensions, for example). However, as described above, when performing signed feature hashing, embodiments of the present invention may avoid constructing the high-dimensional space (the 2⁴⁰ dimensional space) for representing the N-gram. Instead, embodiments of the present invention can hash the N-grams directly into the lower dimensional space (thus bypassing the high-dimensional space).

For every feature (every N-gram) that is represented in the 2⁴⁰ space, embodiments of the present invention take two hashes of the feature. One hash can be a bit hash, such as the application of a function such as [MD5(feature+salt₁) AND 4095]. A second hash can be a sign hash, such as the application of a function such as ([MD5(feature+salt₂) AND 1]−0.5)×2. The bit hash provides a mapping from every dimension (“bin”) of the 2⁴⁰-dimensional space to a corresponding dimension (“bin”) of the 2¹²-dimensional space, which gets updated by the amount given by the value of the sign hash. A salt can be any binary representation.

The hash table representing the 2⁴⁰-dimensional space is generally going to be sparsely populated. N-grams are distributed among 2⁴⁰ locations/bins of the hash table. As long as the hash function is collision resistant, the probability that two non-identical features in the high dimensional space (the 2⁴⁰-dimensional space, in the process of the current example) will both be populated and hash to the same value in the lower-dimensional space (the 2¹²-dimensional space, in the process of the current example) is acceptably low. Identical features will hash to the same location/bin and sign, preserving the inner product if there is no collision.

In view of the above, embodiments of the present invention can use techniques of signed-feature hashing to analyze network traffic in such a way that very low-powered computers (such as mobile phones, or embedded microcomputers in a car) can perform the analysis.

Embodiments of the present invention can then attempt to classify each loaded portion as either (1) corresponding to a threat/threat-signature, or (2) not corresponding to a threat/threat-signature. Embodiments of the present invention can then check their classifications (of the inputs) against the classifications determined by SNORT (of the same inputs). By comparing the classifications, embodiments of the present invention can determine whether their own classifications correctly reflect the classifications provided by SNORT. Although the above example describes comparing the determined classifications to the classifications of SNORT, other embodiments may compare the determined classifications to classifications provided by an IDS different than SNORT.

Depending on the results of the comparisons, embodiments of the present invention can then update/modify the parameters used to classify the portions/records to more accurately reflect the classifications provided by SNORT.

With regard to the parameters for generating the above-described classifications, these parameters can be considered to be weightings that are used in the process of machine learning. As described above, embodiments of the present invention can use SNORT for comparison (SNORT can be used as an “oracle”), and embodiments of the present invention can be trained to reproduce SNORT classifications. Stochastic gradient descent with a hinge loss function can be used. Specifically, any machine-learning technique capable of operating on the hashed feature vector can be used, including stochastic gradient descent with an appropriate loss function in an online context.

Embodiments of the present invention can generate a linear classifier to classify data represented within the lower-dimension hash-table/space (e.g., the 2¹² space described above). Embodiments of the present invention can use the linear classifier to look for a general class of threats (rather than specific threats) by using a reference classifier. Embodiments of the present invention can use an output from the reference classifier to train an efficient classifier such that the efficient classifier provides a good approximation of the output of the reference classifier, with reduced resource requirements.

Embodiments of the present invention analyze each packet of the network traffic. As described above, embodiments of the present invention can use a series of weights. The weights can be used to produce an inner product. For example, for every value in a hash feature vector, there can be a corresponding weight. Embodiments of the present invention can then multiply the values of the hash feature vector by the corresponding weights and thus form a classification of the feature vector that indicates whether the feature vector corresponds to a threat/threat-signature (“bad”) or does not correspond to a threat/threat-signature (“good”).

Specifically, a classifier can be a sign and inner product of <x, w>. “X” can be a space of reduced dimensionality. “W” can be a vector of weights, one for each element in x. Embodiments of the present invention can multiply each value of “X” with a corresponding value of “W” and add the products together. The feature vector can be considered “good” if the calculated value is larger than zero. The feature vector can be considered as “bad” if the calculated value is smaller than zero.

As described above, embodiments of the present invention can compare the determined classifications with the classifications determined by SNORT. In other words, output of the linear classifier can be compared to the output of SNORT. If the outputs do not agree, then the weights (which generated the classifications) are adjusted, and subsequent packets are then received by the IDS to be processed.

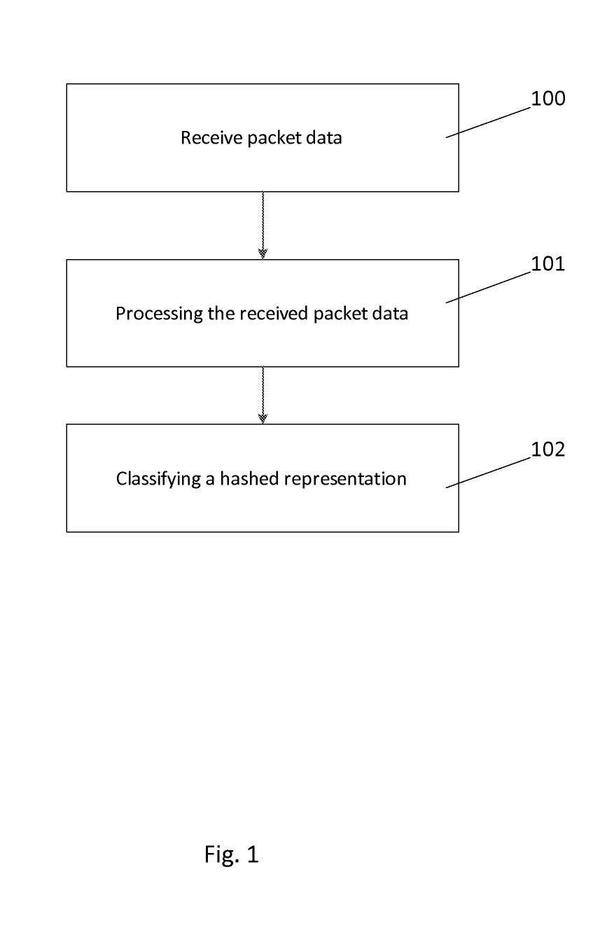

FIG. 1 illustrates a flowchart of a method in accordance with an embodiment of the invention. The method illustrated in FIG. 1 includes, at 100, receiving, by a first network intrusion detection system, packet data that is transmitted in network traffic. The method, at 101, includes processing the received packet data, using feature hashing, into a hashed representation. The hashed representation approximates the expressiveness of a high-dimensional representation of the received packet data. The hashed representation can be stored using less memory compared to the high-dimensional representation. The method, at 102, includes classifying the hashed representation as either corresponding to the threat signature or as not corresponding to a threat signature.

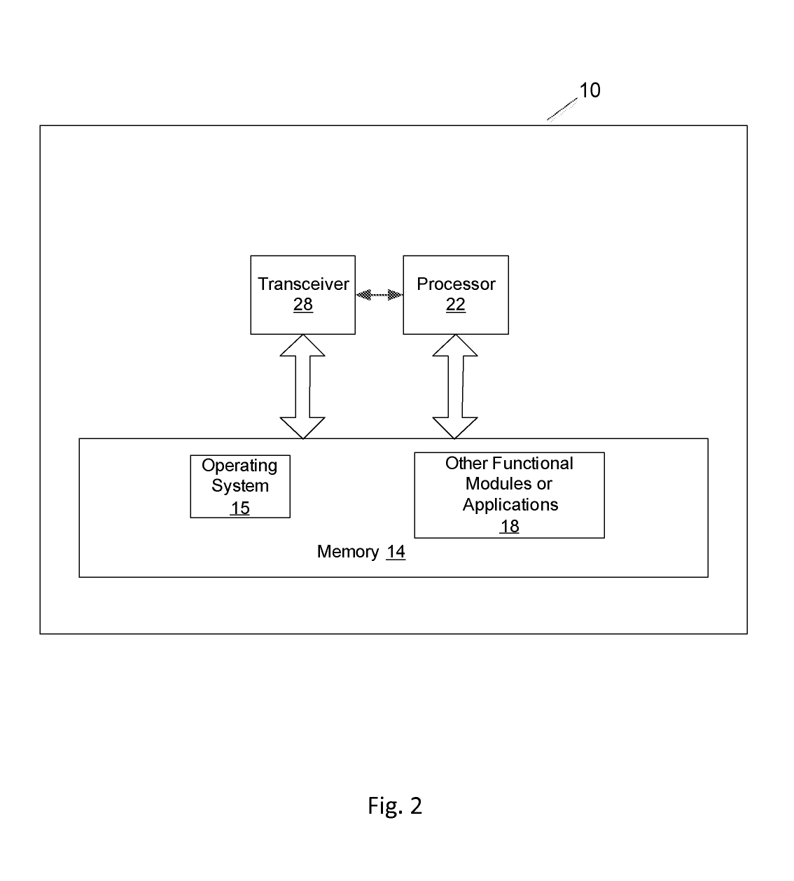

FIG. 2 illustrates an apparatus in accordance with an embodiment of the invention. In one embodiment, the apparatus can be an apparatus configured to perform intrusion detection. Apparatus 10 can include a processor 22 for processing information and executing instructions or operations. Processor 22 can be any type of general or specific purpose processor. While a single processor 22 is shown in FIG. 2, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

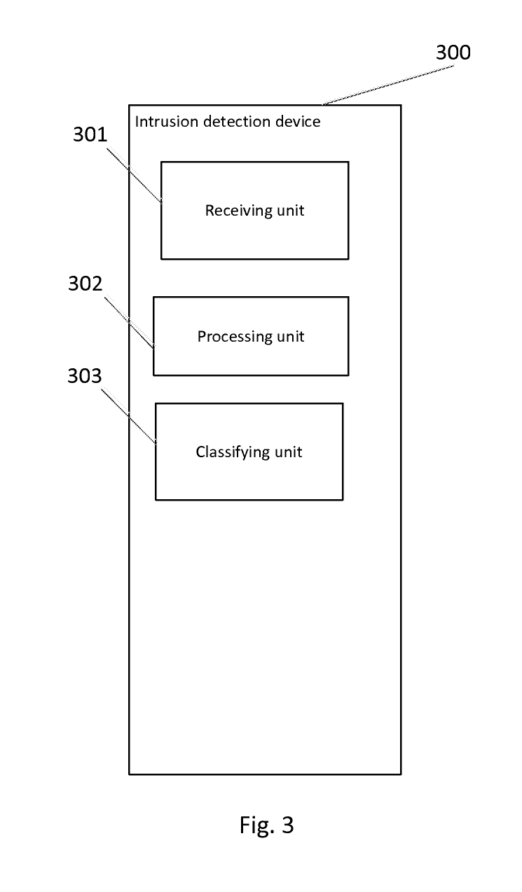

FIG. 3 illustrates an apparatus in accordance with another embodiment. Apparatus 300 can be a device configured to operate as an intrusion detection system, for example. Apparatus 300 can include a receiving unit 301 that receives packet data that is transmitted in network traffic. Apparatus 300 can also include a processing unit 302 that processes the received packet data, using feature hashing, into a hashed representation. The hashed representation approximates the expressiveness of a high-dimensional representation of the received packet data. The hashed representation can be stored using less memory compared to the high-dimensional representation. Apparatus 300 can also include a classifying unit 303 that classifies the hashed representation as either corresponding to a threat signature or as not corresponding to a threat signature. In one embodiment, a single computer can process data alongside an oracle. The single computer can update the weights, and the updated weights can be transmitted to other IDS devices/units that use the same weight vector to perform detection. In other words, SNORT can be run at one location, and the set of weights (that enable embodiments of the present invention to approximate the SNORT output) can be transmitted to the other IDS devices/units. The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
receiving, by a first network intrusion detection system, packet data that is transmitted in network traffic;
processing the received packet data, using feature hashing, into a hashed representation, wherein the hashed representation approximates the expressiveness of a high-dimensional representation of the received packet data, and the hashed representation can be stored using less memory compared to the high-dimensional representation; and
classifying the hashed representation as either corresponding to a threat signature or as not corresponding to a threat signature.

2. The method according to claim 1, wherein the received packet data is not transformed into the high-dimensional representation.

3. The method according to claim 1, further comprising comparing the determined classification to another classification, wherein the another classification is determined by a second network intrusion detection system.

4. The method according to claim 3, further comprising updating the first intrusion detection system based on the comparing, wherein the first intrusion detection system is updated so that the determined classifications more closely resemble the classifications determined by the second network intrusion detection system.

5. The method according to claim 1, wherein the receiving the packet data comprises receiving packet data transmitted in an ad-hoc wireless network.

6. The method according to claim 1, wherein the processing the received packet data comprises using signed-feature hashing.

7. The method according to claim 3, wherein the comparing comprises comparing the determined classification to another classification determined by SNORT.

8. The method according to claim 4, wherein the updating comprises updating weightings for online learning of the first intrusion detection system.

9. The method according to claim 8, wherein the updating is performed on a single device using representative data and the learned weights are then transmitted in compact form to clients for use in intrusion detection without need to reference a secondary classifier.

10. An apparatus, comprising:
at least one processor; and
at least one memory including computer program code,
the at least one memory and the computer program code configured, with the at least one processor, to cause the apparatus at least to
receive packet data that is transmitted in network traffic;
process the received packet data, using feature hashing, into a hashed representation, wherein the hashed representation approximates the expressiveness of a high-dimensional representation of the received packet data, and the hashed representation can be stored using less memory compared to the high-dimensional representation; and
classify the hashed representation as either corresponding to a threat signature or as not corresponding to a threat signature.

11. The apparatus according to claim 10, wherein the received packet data is not transformed into the high-dimensional representation.

12. The apparatus according to claim 10, wherein the apparatus is further caused to compare the determined classification to another classification, wherein the another classification is determined by a second network intrusion detection system.

13. The apparatus according to claim 12, wherein the apparatus is further caused to update the first intrusion detection system based on the comparing, the first intrusion detection system is updated so that the determined classifications more closely resemble the classifications determined by the second network intrusion detection system.

14. The apparatus according to claim 10, wherein the receiving the packet data comprises receiving packet data transmitted in an ad-hoc wireless network.

15. The apparatus according to claim 10, wherein the processing the received packet data comprises using signed-feature hashing.

16. The apparatus according to claim 12, wherein the comparing comprises comparing the determined classification to another classification determined by SNORT.

17. The apparatus according to claim 13, wherein the updating comprises updating weightings for online learning of the apparatus.

18. The apparatus according to claim 17, wherein the updating is performed on a single device using representative data and the learned weights are then transmitted in compact form to clients for use in intrusion detection without need to reference a secondary classifier.

19. A computer program product, embodied on a non-transitory computer readable medium, the computer program product configured to control a processor to perform a process, comprising:
receiving, by a first network intrusion detection system, packet data that is transmitted in network traffic;
processing the received packet data, using feature hashing, into a hashed representation, wherein the hashed representation approximates the expressiveness of a high-dimensional representation of the received packet data, and the hashed representation can be stored using less memory compared to the high-dimensional representation; and
classifying the hashed representation as either corresponding to a threat signature or as not corresponding to a threat signature.

20. The computer program product according to claim 19, wherein the received packet data is not transformed into the high-dimensional representation.

21. The computer program product according to claim 19, wherein the process further comprises comparing the determined classification to another classification, wherein the another classification is determined by a second network intrusion detection system.

22. The computer program product according to claim 21, wherein the process further comprises updating the first intrusion detection system based on the comparing, wherein the first intrusion detection system is updated so that the determined classifications more closely resemble the classifications determined by the second network intrusion detection system.

23. The computer program product according to claim 19, wherein the receiving the packet data comprises receiving packet data transmitted in an ad-hoc wireless network.

24. The computer program product according to claim 19, wherein the processing the received packet data comprises using signed-feature hashing.

25. The computer program product according to claim 21, wherein the comparing comprises comparing the determined classification to another classification determined by SNORT.

26. The computer program product according to claim 22, wherein the updating comprises updating weightings for online learning of the first intrusion detection system.

27. The computer program product according to claim 26, wherein the updating is performed on a single device using representative data and the learned weights are then transmitted in compact form to clients for use in intrusion detection without need to reference a secondary classifier.
